(19) United States
(12) Patent Application Publication
(10) Pub. No.: US 2019/0168170 A1
(43) Pub. Date: Jun. 6, 2019

(54) ANION EXCHANGE MEMBRANE WITH HYDROPHILIC MOIETIES

(71) Applicant: UNIVERSITY OF TENNESSEE RESEARCH FOUNDATION, Knoxville, TN (US)

(72) Inventors: Thomas ZAWODZINSKI, Knoxville, TN (US); Shane FOISTER, Knoxville, TN (US)

(73) Assignee: UNIVERSITY OF TENNESSEE RESEARCH FOUNDATION, Knoxville, TN (US)

(21) Appl. No.: 16/320,804

(22) PCT Filed: Jul. 27, 2017
(86) PCT No.: PCT/US2017/044134

§ 371 Date: Jan. 25, 2019

Related U.S. Application Data
(60) Provisional application No. 62/367,387, filed on Jul. 27, 2016.

(51) Int. Cl. B01D 69/02; H01M 2/16; H01M 8/0239; B01D 67/00

(52) U.S. Cl. CPC B01D 69/02; H01M 2/1653; H01M 2/1673; H01M 8/0239; B01J 41/12; B01D 2325/16; B01D 2325/42; B01D 2325/36; B01D 2323/30; B01D 67/0006

(57) ABSTRACT

An electrochemical device includes an anode, a cathode, and a separator interposed between the anode and cathode. The separator includes an anion conductive membrane having a porous substrate having hydrophilic moieties bonded thereto to increase water availability in a vicinity of ionogenic sites contributing to conductivity of the membrane in a presence of aqueous phases imbibed therein.

### CROSS-REFERENCE TO RELATED APPLICATION

This application claims the benefit of U.S. Provisional Application No. 62/367,387, filed Jul. 27, 2016, the contents of which are hereby incorporated by reference in their entirety.

### TECHNICAL FIELD

In at least one aspect, the present invention is related to anion exchange membranes that can be used in an electrochemical device.

### BACKGROUND

Anion exchange membranes can be used in a number of electrochemical devices such as fuel cells and batteries. In general, anion exchange membranes are semipermeable, typically made from ionomers. These membranes are designed to conduct anions while being impermeable to gases such as oxygen or hydrogen. Increasing membrane conductivity and maintaining cation stability can present issues for anion conductive membranes. One problem is that over time the cation functionality (counter charge anion) is unstable with respect to attack on the cation by the anion.

Accordingly, there is a need for anion exchange membrane with improved stability and durability.

### SUMMARY

The present invention solves one or more problems of the prior art by providing in at least one embodiment an electrochemical device having an anion exchange membrane. The electrochemical device includes an anode, a cathode, and a separator interposed between the anode and cathode. The separator includes an anion conductive membrane having a porous substrate having hydrophilic moieties bonded thereto to increase water availability in a vicinity of ionogenic sites contributing to conductivity of the membrane in a presence of aqueous phases imbibed therein.

In another embodiment, an electrochemical device having an anion exchange membrane is provided. The electrochemical device includes an anode, a cathode, and a separator interposed between the anode and cathode. The separator includes an anion conductive membrane having a porous cross-linked polymeric substrate having non-ionic hydrophilic moieties bonded thereto to increase water availability in a vicinity of ionogenic sites contributing to conductivity of the membrane in a presence of aqueous phases imbibed therein. The hydrophilic moieties are functionalized with cations that are chemically modified to hinder degradation by substitution or elimination reactions.

### BRIEF DESCRIPTION OF THE DRAWINGS

FIG. 1 is a schematic cross section of an electrochemical device having an anion exchange membrane.

FIGS. 2A-2E are synthetic schemes for generation 0-4 membranes illustrated using 2-methylimidazole and 1,2-dimethylimidazole nucleophiles.

FIG. 3 is a general synthetic scheme for preparation of generation 0 cross-linked loaded anion membranes (CLAMs).

FIGS. 4A and 4B illustrate possible models for CLAM formation.

FIG. 5 illustrates the scope of nitrogen-based nucleophiles suited for preparation of generation 0 CLAMs.

FIGS. 6A and 6B illustrate oxygen-based nucleophiles in generation 0 CLAMs.

FIG. 7 illustrate mixed nucleophiles in generation 0 CLAMs.

FIGS. 8A and 8B illustrate blended and grafted copolymers in generation 0 CLAMs.

FIG. 9 illustrates generation 2 CLAM/anion exchange membrane (AEM) synthesis.

FIG. 10 illustrates generation 3 CLAM/AEM synthesis for imdazole-based nucleophiles.

FIG. 11 illustrates a generation 4 CLAM and AEM scheme.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include alkyl, lower alkyl, C₁₋₆ alkyl, C₆₋₁₀ aryl, or C₆₋₁₀ heteroaryl; single letters (e.g., “n” or “o”) are 1, 2, 3, 4, or 5; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The term “alkyl” refers to C₁₋₂₀ inclusive, linear (i.e., “straight-chain”), branched, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms.

Throughout this application, where publications are referenced, the disclosures of these publications in their entireties are hereby incorporated by reference into this application to more fully describe the state of the art to which this invention pertains.

### Abbreviations

“2Melm” means 2-methylimidazole.
“AEM” means anion exchange membrane.
“BZLM” is benzimidazole.
“CLAM” means cross-linked loaded anion membranes.
“PPO” means poly(p-phenylene oxide).
“PPO-Br” means brominated poly(p-phenylene oxide).
“TEG” is triethylene glycol.
“TFE” means 1,1,1-trifluoroethanol.
“Tz” means triazole.
The term “ionogenic” refers to the ability of an ion to form ions.

In at least one aspect, a polymer membrane is designed to conduct anions. This polymer contains fixed cationic moieties that have been modified with hydrophilic chemical functionalities to attract water or solution into the polymer to assist the dissociation of free anions from the fixed cation sites, which can lead to high conductivity. Other arrangements are also contemplated. For example, non-hydrophilic chemical functionalities can also be incorporated to alter the conformational properties of cationic groups or to increase the number of cationic groups attached to the polymer.

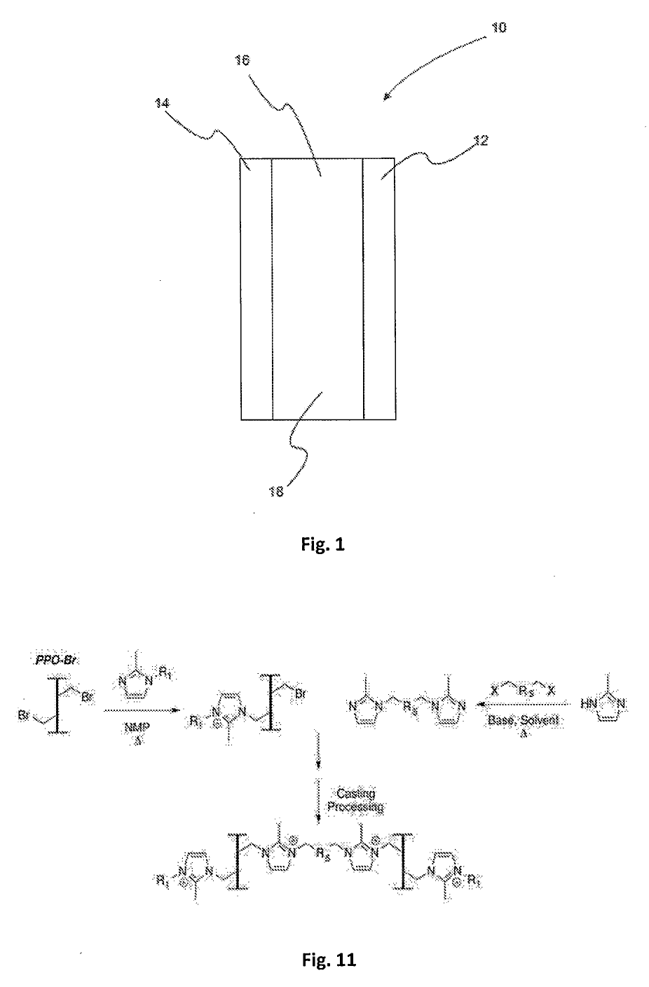

With reference to FIG. 1, a schematic cross section of an electrochemical device that incorporates an anion exchange membrane is provided. Suitable electrochemical devices include fuel cells and batteries. Electrochemical device 10 includes anode 12 and cathode 14. Separator 16 is interposed between the anode and cathode. Characteristically, separator 16 includes an anion conductive membrane including a porous substrate 18 having hydrophilic moieties bonded thereto to increase water availability in a vicinity of ionogenic sites contributing to conductivity of the membrane in a presence of aqueous phases imbibed therein. In one refinement, the hydrophilic moieties are functionalized with cations. In a further refinement, the cations are chemically modified to hinder degradation by substitution or elimination reactions by the positioning of sterically hindering groups in the vicinity of the cations. Typically, the hydrophilic moieties can be non-ionic and the substrate is polymeric.

Separator 16 is characterized by both a high water uptake, ion exchange capacity, and anion conductivity. For example, the water uptake is typically greater than 50 percent. As used herein, the water uptake is the weight percent of water imbibed into the membrane as a percent of the weight of the membrane. In a refinement, the water uptake is from 40 to 1500 percent. The ion conductivity is typically greater than 0.30 S/m. In a refinement, the ion conductivity is from 0.3 to 6 S/cm. Typically, the ion exchange capacity is great then 0.3 mmol/g. In a refinement, the ion exchange capacity is from 0.3 to 1.5 mmol/g.

It should also be appreciated that the separator composition can be blended with or copolymerized with a number of additives to modify the water uptake, ion exchange capacity, and ion conductivity. Examples of such additives that can be copolymerized with the separator composition include, but are not limited to, polyethylene glycol, triethylene glycol, triethylene glycol, and the like. Polyvinylchloride is an example of an additive that can be blended with the separator composition.

In a variation, the substrate includes a polymer having polymer fragments represented by the following formula:

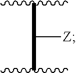

where

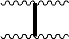

is a section of a polymeric backbone that can be repeated multiple times throughout the polymer chains Z is the residue of a nucleophile. Examples for Z include, but are not limited to:

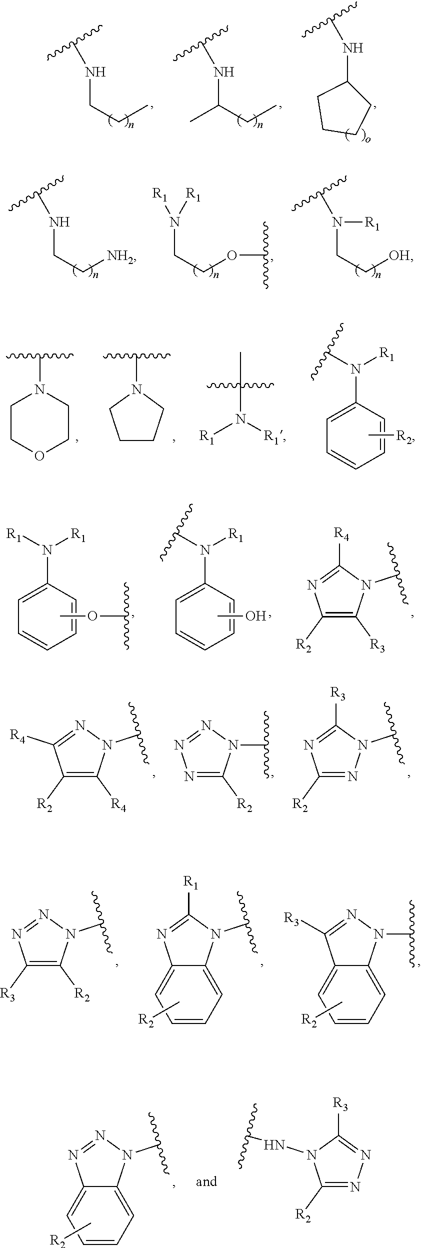

where
o is 1, 2, or 3; n is 1-5; R₁, R_{1′} is H, C₁₋₆ alkyl, or benzyl and R₂, R₃, R₄ are each independently C₁₋₆ alkyl, C₆₋₁₀ aryl, C₆₋₁₀ heteroaryl, CN, halo, NH₂, SH, SMe, NO₂, or CO₂H.

In some variations polymer chains of the substrate are cross-linked as set forth below in more detail. In one refinement, polymer chains of the substrate are cross-linked with a linking moiety Y selected from the group consisting of:

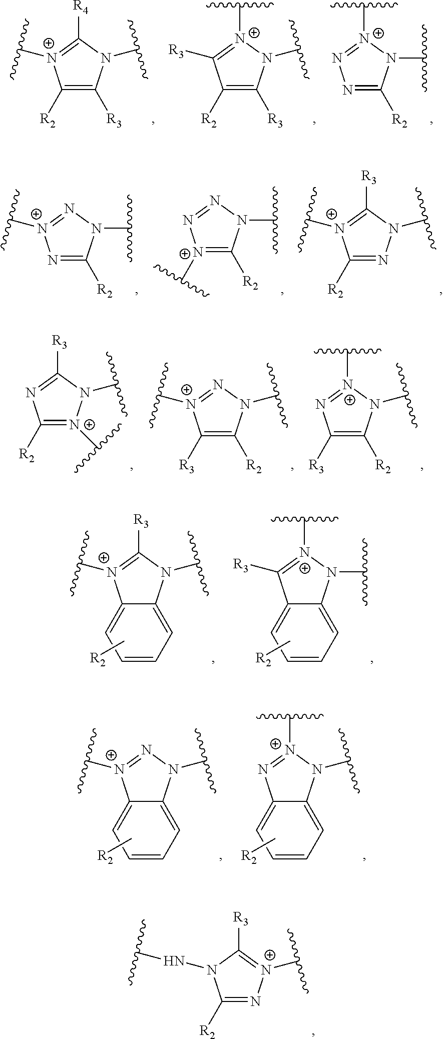

and combinations thereof,
where R₂, R₃, R₄ are each independently C₁₋₆ alkyl, C₆₋₁₀ aryl, C₆₋₁₀ heteroaryl, CN, halo, NH₂, SH, SMe, NO₂, or CO₂H. In a refinement, the substrate includes a polymer having polymer fragments represented by the following formula:

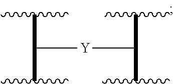

where

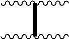

is a section of a polymeric backbone that can be repeated multiple times throughout the polymer chains.

In another variation, polymer chains of the substrate are cross-linked by a moiety having the formula:

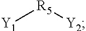

wherein R₅ is a linking group (e.g., phenlyene, C₆₋₁₂ arylene, (CH₂)ₚ where p=1, 2, 3, 4 or 5); and Y₁ and Y₂ are each independently selected from the group consisting of:

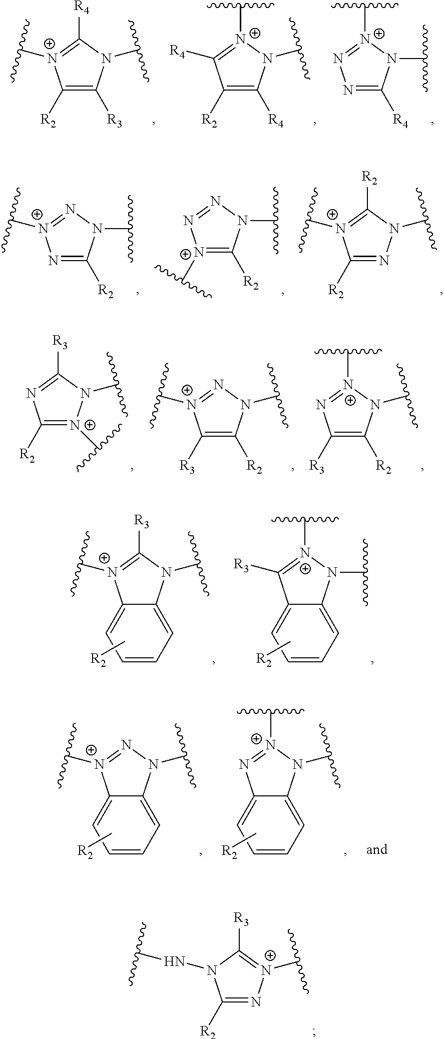

where R₂, R₃, R₄ are each independently C₁₋₆ alkyl, C₆₋₁₀ aryl, C₆₋₁₀ heteroaryl, CN, halo, NH₂, SH, SMe, NO₂, or CO₂H. Examples for R₅ are (CH₂)ₖ and (OCH₂CH₂)ₖO where k is 1-6 (i.e, 1, 2, 3, 4, 5, or 6). In a refinement, the substrate includes a polymer having polymer fragments represented by the following formula:

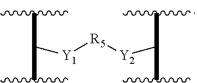

In another refinement, the substrate includes a polymer having polymer fragments represented by the following formula:

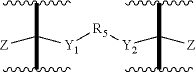

wherein Z is the residue of a nucleophile. Examples for Z in this refinement include, but are not limited to:

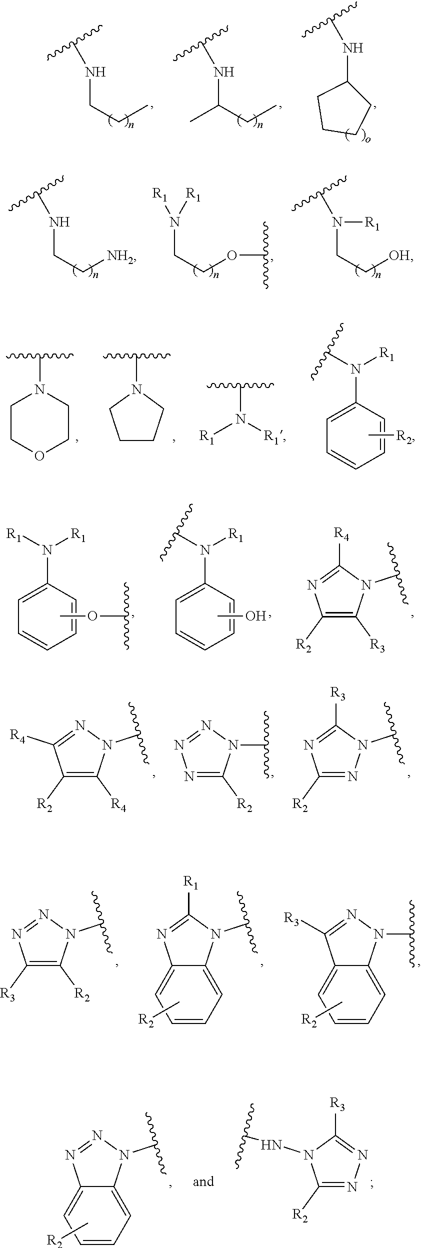

where o is 1, 2, or 3; n is 1 to 5 (e.g., 1, 2, 3, 4 or 5); and R₂, R₃, R₄ are each independently C₁₋₆ alkyl, C₆₋₁₀ aryl, C₆₋₁₀ heteroaryl, CN, halo, NH₂, SH, SMe, NO₂, or CO₂H.

Increasing membrane conductivity and maintaining cation stability can present issues for anion conductive membranes. One problem is that over time the cation functionality (counter charge anion) is unstable with respect to attack on the cation by the anion. Certain embodiments described herein attempt to address at least some of these issues. In one example, a polymer membrane is designed to conduct anions. This polymer contains fixed cationic moieties that have been modified with hydrophilic chemical functionalities to attract water or solution into the polymer to assist the dissociation of free anions from the fixed cation sites, which can lead to high conductivity. Other arrangements are also contemplated. Non-hydrophilic chemical functionalities can also be incorporated to alter the conformational properties of cationic groups or to increase the number of cationic groups attached to the polymer.

A theme in the design of membranes described herein is the attachment of combinations of cationic groups and structural elements to brominated sites on a poly(p-phenylene oxide) PPO polymer backbone. Anion exchange membranes (AEMs) and cross-linked loaded anion membrane (CLAM)-type membranes examined to date can be grouped into five generations, four of which have been adapted to yield CLAM-type morphologies and activities. Each successive generation of membrane incorporates additional synthetic steps and new opportunities for chemical diversity via cationic and structural building blocks. General synthetic schemes for each generation of membrane (using 2-methylimidazole and 1,2-dimethylimidazole nucleophiles) are illustrated in FIGS. 1A through 1E.

These synthetic schemes also highlight the difference between internal nucleophiles, containing two nucleophilic groups, and peripheral nucleophiles that can only react once. The former class of nucleophiles provides a means of crosslinking polymer chains either directly or through a chemical linker (structural element). Oxygen-based nucleophiles can also be employed to introduce a structural element though their reaction with an electrophile that does not produce a cation.

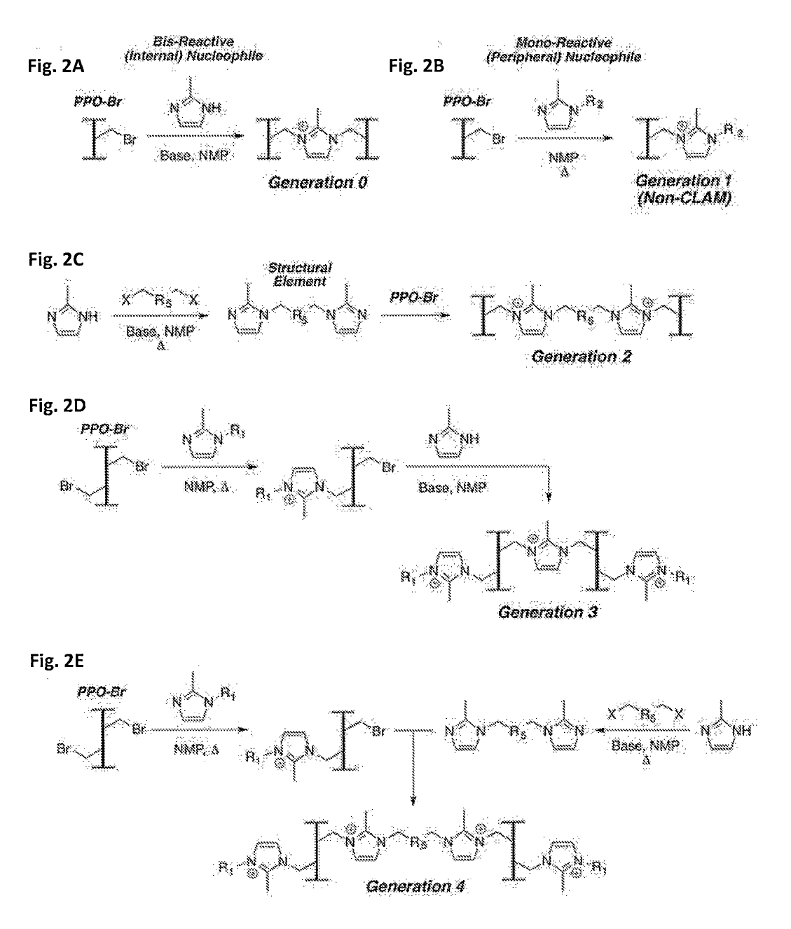

The synthetic schemes in FIGS. 2A, 2C, 2D and 2E, and the pool of possible cationic and structural building blocks are applicable to the synthesis of standard AEMs as well as CLAMs. The preparation of CLAM-type membranes differs from AEM preparation in at least three key ways that influence the composition of CLAMs:

(i) Relatively concentrated solutions of PPO-Br in N-methylpyrrolidone (NMP) (4-8% wt.) are used to prepare pre-casting solutions for CLAMs (high density of reactive sites per square centimeter).
(ii) Modification of PPO-Br by azole nucleophiles is achieved at ambient temperatures for relatively short durations (10-50 min.), without isolation of products by precipitation (reactions between nucleophiles and electrophilic sites on the polymer are likely not complete prior to casting).
(iii) Pre-casting solutions of modified PPO are transferred to aluminum or glass surfaces which are then heated (60-90° C.) without application of vacuum (heating without vacuum does not remove all of the NMP from the film and might allow additional reaction before solidification, and residual NMP could also be a functional component of the CLAM by participating in network formation via hydrogen bonding).

### General Synthetic Scheme for Generation 0 CLAMs

Generation 0 CLAMs were designed to use an internal nucleophile that becomes a cationic group after crosslinking PPO. Initial attempts at preparation of these membranes using normal reaction durations or non-ambient temperatures led to solidification of the polymer solution before it could be cast into films. Further experiments defined reaction conditions that allowed modified PPO to be cast prior to solidification. Residual NMP can also be a functional component of the CLAM by participating in network formation via hydrogen bonding.

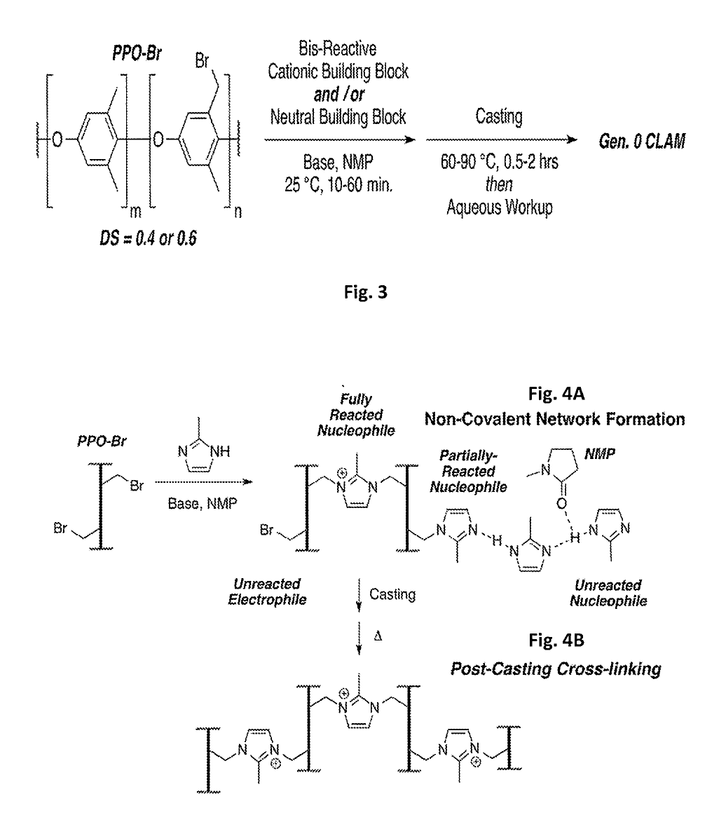

FIG. 3 describes a general synthetic scheme for the preparation of generation 0 CLAMs. PPO-Br (DS=0.4 or 0.6) is mixed with a bis-reactive nucleophile in NMP and the resulting mixture is stirred vigorously for 10-60 minutes. Higher concentrations of PPO-Br or higher DS PPO-Br require shorter reaction times than dilute or lower DS polymer. Nitrogen-based nucleophiles can be used without the need for addition of base while oxygen-based, neutral nucleophiles work better with base added. Several bases were found to be suitable for use in the above reactions including: diisopropylethylamine (DIEA), triethylamine (TEA), sodium or potassium tert-butoxide (NaOtBu or KOtBu), and sodium hydride (NaH). When NaH is used as the base, it is pre-mixed with the nucleophile in NMP and the resulting solution is filtered prior to being added to the polymer solution. Following modification of PPO-Br, the crude pre-casting solution of polymer is transferred to a casting surface (glass or aluminum), defined by scotch tape, via a pipette. The casting surface is then heated in an oven or on a hot plate before being soaked in DI water. The tape is then removed from the casting surface followed by the films themselves. Anion exchange reactions are then carried out by soaking the obtained films in a solution containing the desired anion (e.g., KOH) followed by washing with DI water. The relative stoichiometries of PPO-Br, nucleophile, and base can be tuned to alter the thickness and properties of the membrane. Membrane thickness can also be tuned by altering the volume of pre-casting solution applied to the casting surface as well as by changing the duration and temperature the films are treated at prior to aqueous workup.

### Specific Representative Example of Generation 0 CLAM Preparation

A 10% wt. solution of PPO-Br (DS=0.4) in NMP (0.75 mL=0.195 mmol Br) was added to a vial with a magnetic stir bar. NMP (0.305 mL) was added, followed by a 1M solution of 2-methylimidazole in NMP (0.195 mL=0.195 mmol). The above solution was stirred vigorously as DIEA (0.038 mL=0.215 mmol) was added. The vial was then capped and the mixture stirred for 25 minutes at ambient temperature. The solution was then transferred via pipette to a (5 cm×5 cm) glass surface defined by three layers of scotch tape. The glass plate was then placed in a 90° C. oven for 25 minutes. The glass plate was then removed from the oven and submerged in a DI water bath. When the plate had cooled to ambient temperature, the tape was removed and the plate was again submerged in a DI water bath. The film was then removed and soaked in an aqueous solution of KOH.

### Possible Working Models for CLAM Formation

The differences between CLAM and standard AEM preparation described above suggest a few possible models for CLAM formation (FIGS. 4A and 4B). Given the short durations and ambient conditions used for modification of PPO-Br by nucleophiles, it is reasonable to assume that pre-casting polymer solutions contain a mixture of fully reacted (crosslinking) nucleophile, partially-reacted nucleophile, unreacted nucleophile and unreacted electrophile. The absence of vacuum during heating implies that significant amounts of NMP remain in the film prior to aqueous workup and this residual NMP may allow reorganization of the species present. It is possible that hydrogen bonding between partially-reacted and unreacted nucleophiles (and possibly NMP) could produce non-covalent networks which reinforce the cationic crosslinks arising from fully reacted nucleophiles (FIG. 4A). It is also possible that residual NMP facilitates further reaction of partially-reacted nucleophiles with unreacted electrophiles, producing additional cationic crosslinks between polymer chains (FIG. 4B).

### Scope of Nitrogen-Based Nucleophiles Suitable for Generation 0 CLAM Preparation

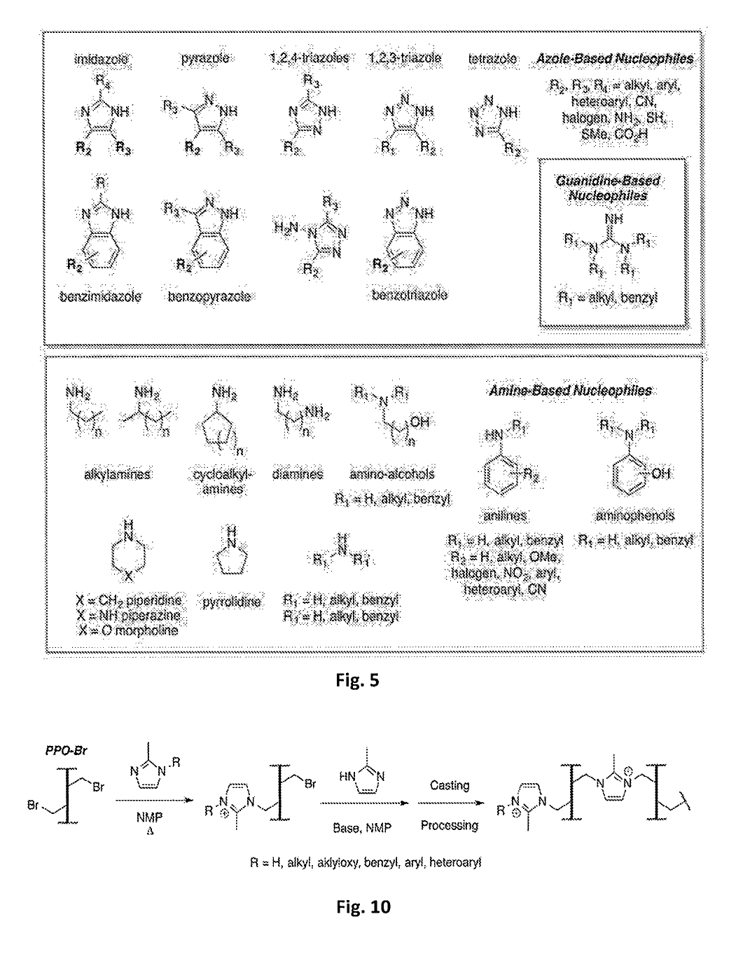

The proposed working models above and the experiments performed with different nucleophiles can be used to define the set of nucleophiles suited to the preparation of generation 0 CLAMs. Nucleophiles yielding cationic groups are nitrogen-based building blocks including azoles, guanidines, and amines (FIG. 5). Diversity in these classes of nucleophilic building blocks arise from different capacities to delocalize positive charges, different degrees of conformational flexibility, differences in hydrophilic character, and different stabilities to degradation by aqueous base. Some general requirements for nucleophiles in each of the above classes seem to include the following:

(i) The nucleophile must contain two reactive sites either on the same nitrogen or on different nitrogen atoms.
(ii) The nucleophile should contain at least one —NH group.
(iii) The nucleophile should contain a nitrogen or oxygen atom bearing a lone pair capable of accepting hydrogen bonds.
For azoles, this implies a second nitrogen atom in addition to the —NH group. For guanidines, the —NH group can serve both purposes. For primary or secondary amines, the —NH₂ or —NH group, respectively, can serve both purposes; however, the formation of cationic groups requires that at least some of the amine building block is per-alkylated with partially- or unreacted amine participating in hydrogen bonding. Amino-alcohols and aminophenols represent special cases wherein the nitrogen atom can serve as a nucleophile while the appended —OH group can act as both hydrogen bond acceptor and donor. Thus primary, secondary or tertiary amines can be used in these classes.

Azoles are the preferred building blocks for generation 0 CLAMs, possibly owing to their ability to participate in π-π stacking with the polymeric backbone, their ability to form highly directional hydrogen bonds, or their more rigid conformations when attached to the polymer backbone.

### Scope of Oxygen-Based Nucleophiles Suitable for Generation 0 CLAM Preparation

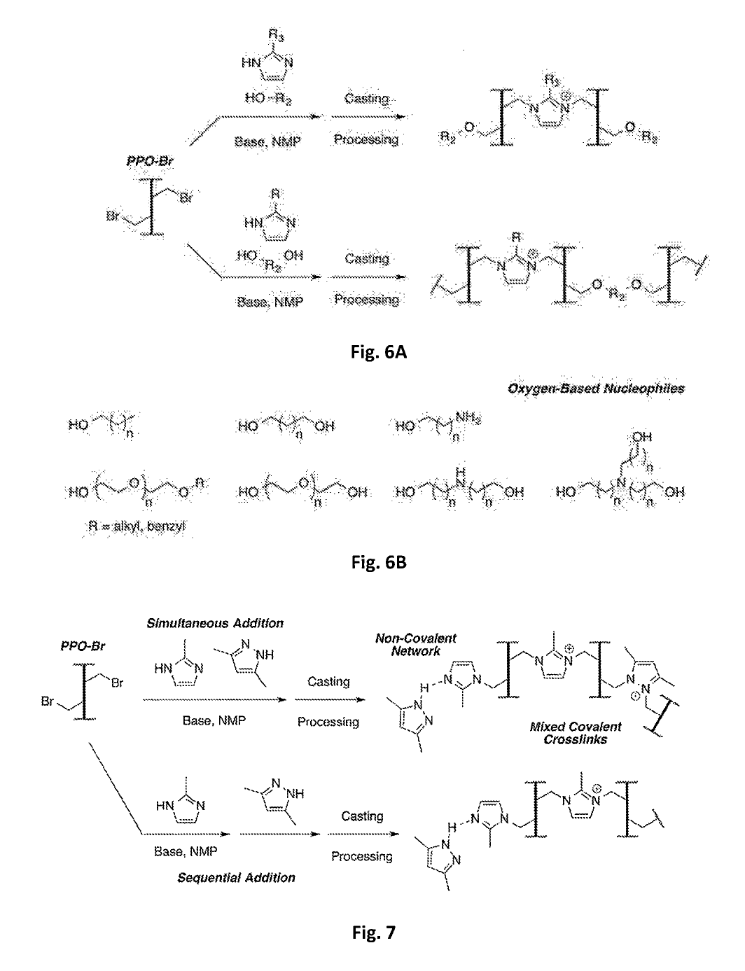

Non-cationic structural elements can be added to generation 0 CLAMs by using combinations of alcohol-based building blocks with nitrogen-based nucleophiles to generate cationic groups. (FIG. 6A). The alcohol building blocks can react covalently with PPO-Br to form ethers or can participate in hydrogen bonding in non-covalent networks. The chemical features of the alcohol building blocks can be used to influence the physical properties of the cation-modified polymer (e.g. hydrophilicity). Alcohols, diols, and polyols can be employed as oxygen-based nucleophiles, similar to those described in FIG. 5; however, reactions with PPO-Br to yield ethers require the addition of one of the bases mentioned above (FIG. 6B).

### Mixed Nucleophiles in Generation 0 CLAMs

Combinations of nitrogen- and/or oxygen-based nucleophiles can be used to construct CLAMs by adding the desired building blocks simultaneously or sequentially to PPO-Br. Much like the approaches described in FIG. 6A, using multiple nucleophiles allows multiple properties of the membrane to be tuned at once. Combining different types of nucleophiles could also be envisioned to conformationally alter non-covalent networks if such species are present (FIG. 7).

### Blended and Grafted Copolymers in Generation 0 CLAMs

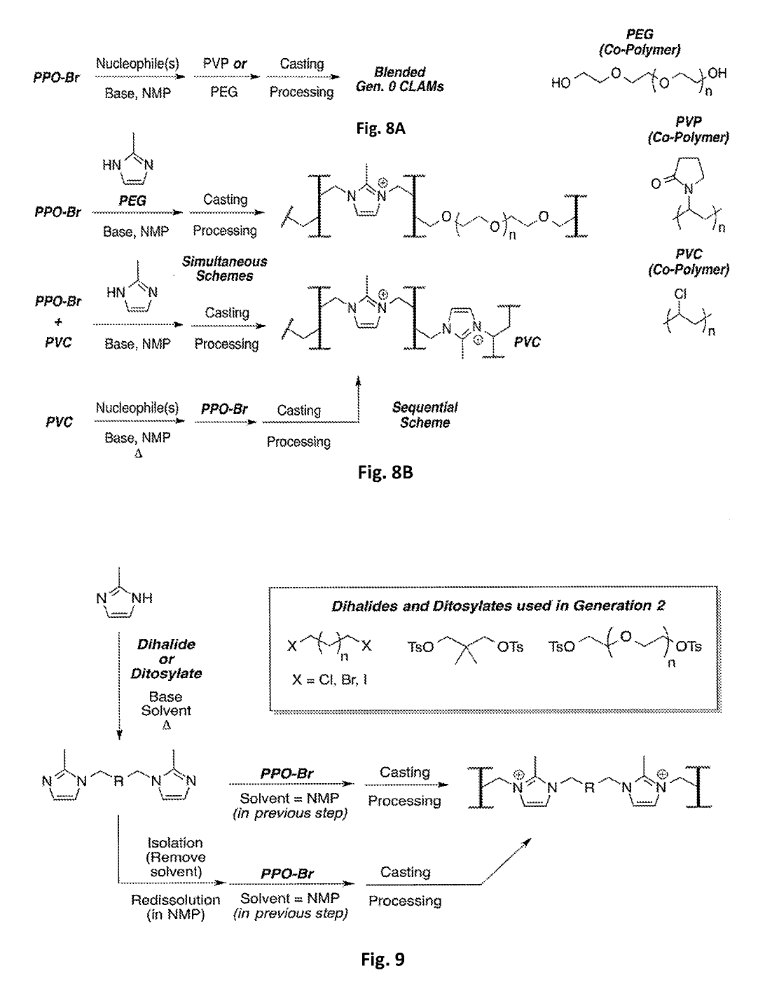

Blended membranes can be prepared by the simultaneous or sequential addition of copolymers to mixtures of nucleophiles and PPO-Br (FIG. 8A). Non-covalent association of the copolymer with modified PPO can enhance the mechanical properties of the membrane. Polyvinylpyrrolidone (PVP) is composed of monomers that are structurally similar to NMP, the solvent used to cast CLAMs (FIGS. 8A and 8B). Polyethyleneglycol (PEG) can be blended with or covalently grafted to PPO, depending on the presence of base and reactive sites on PPO-Br. Polyvinyl chloride (PVC) can be grafted onto PPO-Br via the nucleophiles discussed in previous schemes. Simultaneous or sequential reaction sequences can be used to favor particular linkages between polymers and nucleophiles (FIG. 8B). Also, a generation 1 modified PPO polymer (discussed below) can be used as the copolymer in CLAM preparation to yield a CLAM-AEM composite. Moreover, it is also possible to use a generation 1 modified PPO polymer as the copolymer in CLAM preparation. These are essentially CLAM-AEM composites

### Processing and Workup of Generation 0 CLAMs

A feature of CLAM-based processing is a heating step (without vacuum) following casting. This may facilitate crosslinking as illustrated in FIG. 4B. Application of vacuum following heating can influence the thickness of the membrane by removing residual NMP; however, complete drying of the membranes does reduce performance and mechanical stability. Following heat treatment and/or vacuum, CLAMs are soaked in DI water and removed from glass or aluminum casting surfaces. The membranes should then be stored such that they do not dry out completely as this renders them brittle.

### Generation 1 AEMs

The scheme for preparation of generation 1 AEMs (FIG. 2B) is by far the most commonly employed approach to AEM preparation in the chemical literature. This scheme essentially incorporates a structural element by attachment to the cation precursor, prior to mixing with PPO-Br. Thus nucleophiles used in generation 1 schemes are mono-reactive and cannot crosslink the polymer backbone. Several attempts to prepare CLAM-type membranes using this approach have been attempted with no success. Following post-casting heating, exposure of the films to water does not yield a membrane probably because the films do not solidify (no crosslinking): The mono-reactive nucleophiles lack an NH or OH group which can participate in hydrogen bond donation and thus cannot form a network. The films can be heated under vacuum to yield films with low to moderate conductivity.

### General Scheme for Generation 2 CLAMs and AEMs

These classes of membranes incorporate additional structural elements, relative to their generation 0 analogs, via an additional pre-casting synthetic step. Specifically, nitrogen-based nucleophiles (internal) are first reacted with poly-reactive electrophiles such dihalides and ditosylates before mixing with PPO-Br (FIG. 9). This extra synthetic step yields poly-reactive (e.g. bis-reactive) cation precursors separated by chemical linkers. These intermediates can be isolated or added as crude products directly to PPO-Br. Reaction of these intermediates with electrophilic sites on the PPO-Br was designed to crosslink polymer backbones; however, the same arguments made for non-covalent networks in generation 0 can also be applied here. Higher concentrations of PPO-Br and a heating step prior to application of vacuum during membrane processing distinguish generation 2 CLAMs from AEMs. Combinations of nucleophiles and/or chemical linkers can be applied to the above scheme as described in the section on generation 0 membrane preparation. The same pool of nucleophiles described previously can be applied to the scheme in FIG. 9 as can blending or grafting with copolymers.

### General Scheme for Generation 3 CLAMs and AEMs

This class of membranes incorporates elements of generation 0 and generation 1 analogs by using both internal and peripheral nucleophiles to modify the PPO backbone (FIG. 10). The different types of nucleophiles can be added simultaneously or in sequence, although modifications with peripheral nucleophiles do not lead to solidification of the PPO-Br. Thus, sequential modification of PPO-Br first with peripheral nucleophiles (with heating) followed by addition of internal nucleophiles ensures more predictable product distributions. Peripheral nucleophiles applicable to this approach include any of those described in FIG. 5 wherein the NH group is replaced with NR. Many of these materials are commercial and those that are not can be prepared by alkylation with the appropriate electrophile. The same distinctions made between CLAM and AEM preparation in the preceding schemes apply to generation 3.

### General Scheme for Generation 4 CLAMs and AEMs

This class of membranes incorporates elements of generation 1 and generation 2 by using peripheral nucleophiles with internal nucleophiles connected by chemical linkers. Reactions of internal nucleophiles with dihalides/ditosylates and reactions of PPO-Br with peripheral nucleophiles can be carried out in parallel before being mixed together (FIG. 11). The same nucleophiles, chemical linkers, and opportunities for blending or grafting copolymers can be applied to this class of membranes as have been described in previous schemes above. Combinations of different types of nucleophiles (both peripheral and internal) as well as changes to their relative stoichiometries can also be used to tune the properties of generation 4 membranes.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

All membranes were prepared by solvent casting onto glass plates with casting surfaces defined by layers of scotch tape. Pre-casting polymer solutions were transferred to casting surfaces by pipette and the glass plates were then heated at 90° C. for a specified time interval (dependent on the chemical nature of components in the pre-casting solution). 0.05 mL of pre-casting solution was applied for each cm² of casting surface. The glass plates were then soaked in DI H₂O and removed from the glass surface by scraping. The membranes were then soaked in 1M KOH (aq) overnight and washed with DI H₂O.

Experimental Protocol (Generic):

PPO-Br (10% wt/NMP) was added to a solution of azole and DIEA in NMP. Different stoichiometries (ratios of azole to reactive bromide sites on PPO) have been examined and each showed promise in conductivity experiments (>0.25 S/cm). Our standard conditions now use 1.05 equivalents of azole relative to the number of reactive (Br) sites on the PPO polymer and 1.10 equivalents of DIEA, a non-nucleophilic base. This pre-casting mixture is stirred for a defined time interval (length depends on the chemical nature of the azole) before casting. For 2-methylimidazole, the pre-casting mixture is stirred for 12-15 minutes at ambient temperature before being transferred to a casting surface defined by 3 layers of scotch tape. After heating in an oven (again the duration of heating depends on the chemical nature of the azole), the glass plate is soaked in DI water and the membrane removed by scraping. For 2-methylimidazole, 20-30 minutes of heating at 90° C. is employed. The isolated membranes are then soaked in 1M KOH (aq) overnight and washed with DI water prior to use.

Experimental Protocol (Specific):

2-methylimidazole (348 mg, 4.224 mmol) and DIEA (0.773 mL, 4.435 mmol) were dissolved in NMP (1.5 mL) with stirring. PPOBr, 10% wt solution in NMP obtained from Akron Polymers, (6 mL, 4.032 mmol Br) was then added to the above solution and the resulting mixture was stirred for 12 minutes at ambient temperature (25° C.). 3.75 mL of the pre-casting solution was then transferred, via pipette, to 7.5 cm×10 cm casting surfaces defined by 3 layers of scotch tape (duplicate experiment) on glass plates. The glass plates were then heated in a 90° C. oven for 20 minutes. The glass plates were then soaked in DI water, the scotch tape was removed using razor blades, and the membranes were removed by scraping. The membranes were then transferred to petri dishes and soaked in 1M KOH (aq) overnight. The membranes were then washed with DI water and stored in sealed plastic bags until needed. The product membranes in this case were SF-02-77A and SF-02-77B.

Experimental Protocol (Generic):

To a solution of azole and D1EA in NMP was added a ditosylate or dibromide. The resulting solution was heated for 30 minutes with stirring. PPO-Br (10% wt solution in NMP from Akron Polymers) was then added to the above solution and the mixture was stirred at ambient temperature for 15 minutes. The pre-casting solution was then transferred to the casting surface, defined by 3 layers of scotch tape, via pipette. The glass plate was then heated in an oven at 90° C. for 20-30 minutes. The plate was then soaked in DI water, the tape spacers were removed with a razor blade, and the membrane was removed by scraping. The membrane was then transferred to a petri dish, soaked in 1M KOH (aq) overnight, and then washed with DI water. The membrane was stored in a sealed plastic bag until needed. Experimental Protocol (Specific): 2-methylimidazole (348 mg, 4.234 mmol) and DIBA (0.773 mL, 4.435 mmol) were dissolved in NMP (0.492 mL). A 2M solution of bis-(p-toluenesulfonate)tetraethyleneglycol in NMP (1.008 mL, 2.016 mmol) was then added and the resulting mixture was stirred at 80° C. for 35 minutes. Upon cooling, PPO-Br (6 mL, 4.032 mmol Br sites) was then added to the above solution and the mixture was stirred at ambient temperature for 15 minutes. 3.75 mL of the above pre-casting solution was then transferred to each of two 7.5 cm×10 cm casting surfaces defined by 3 layers of scotch tape on glass plates. The glass plates were then heated in an oven at 90° C. for 20 minutes. The glass plates were then soaked in DI water, the tape spacers removed with razor blades, and the membrane removed by scraping. The membranes were then transferred to petri dishes, soaked in 1M KOH (aq) overnight, washed with DI water and stored in sealed plastic bags until needed. The product membranes in this case were SF-02-107A and SF-02-107B.

Table 1 provides the properties of a membranes made by the methods set forth herein from PPO-BR and 2-methylimidazol. In general, the membranes were prepared at 8M KOH at 60° C. The ion conductivity ranges from 0.37 to 0.53 S/cm and the ion exchange capacity from 0.73 to 1.66 mmol/g. It is observed that decreasing amounts of 2-methylimidazol result in more variability in initial measured conductivities. Co-blending with PVC improves mechanical properties without sacrificing conductivity. It is also observed that co-additives have profound effect on water uptake, OH uptake, and IECs.

TABLE 1
AEMs Based on PPO-BR and 2-Methylimidazol

| | Equiv. | Conductivity | Durability | | Water | OH Uptake | | IEC |
|---|---|---|---|---|---|---|---|---|
| Additive | [2MeIm] | [S/cm] | [Days] | σ_{f}/σᵢ | uptake [%] | [%] | λ_{H2O} | [mmol/g] |
| 0 | 0.25 | 0.37 | >90 | 0.51 | 42 | 0.57 | 16.5 | 1.41 |
| 0 | 0.50 | 0.42 | >90 | 0.48 | 51 | 0.83 | 17.2 | 1.66 |
| 0 | 1.05 | 0.43 | >90 | 0.72 | 57 | 0.78 | 19.2 | 1.65 |
| 0 | 1.50 | 0.51 | 23 | 0.88 | 61 | 0.89 | 19.7 | 1.72 |
| 8% PVC | 1.05 | 0.44 | >90 | 0.66 | 714 | 6.96 | 536 | 0.74 |
| TEG | 1.05 | 0.53 | >60 | 0.79 | 1268 | 11.68 | 1370 | 0.73 |

Table 2 provides the properties of a membranes made by the methods set forth herein from PPO-BR and various heterocyclic nucleophiles. The ion conductivity ranges from 0.53 to 0.88 S/cm and the ion exchange capacity from 0.23 to 1.39 mmol/g. In general, 2-methyl imidazole shows best overall stability and conductivity

TABLE 2
Effect of Heterocycle

| Heterocyclic | Cond | Durability | | Water uptake | OH Uptake | | IEC |
|---|---|---|---|---|---|---|---|
| group | [S/cm] | [Days] | σ_{f}/σᵢ | [%] | [%] | λ_{H2O} | [mmol/g] |
| 1,2,4-Triazole | 0.38 | 20 | 0.53 | 571 | 5.14 | 1379 | 0.23 |
| Pyrazole | 0.41 | 24 | 0.59 | 210 | 5.32 | 84 | 1.39 |
| Benzimidazole | 0.45 | 22 | 0.60 | 568 | 1.74 | 3944 | 0.08 |
| Imidazole | 0.48 | >60 | 0.88 | 615 | 3.84 | 560 | 0.61 |

Table 3 provides the properties of a membranes made by the methods set forth herein from PPO-BR various heterocyclic nucleophiles and additive. The ion conductivity ranges from 0.43 to 0.51 S/cm and the ion exchange capacity from 0.31 to 0.97 mmol/g. This data shows that adding a hydrophilic linker increases water content and OH uptake.

TABLE 3
Addition of Chemical Diversity Elements

| Building | | Conductivity | Durability | | Water uptake | OH Uptake | | IEC |
|---|---|---|---|---|---|---|---|---|
| Block | Additive | [S/cm] | [Days] | σ_{f}/σᵢ | [%] | [%] | λ_{H2O} | [mmol/g] |
| 2MeIm | TEG | 0.48 | 16 | 0.92 | 1268 | 11.68 | 964 | 0.73 |
| None | TEG | 0.43 | >40 | 0.70 | 626 | 5.95 | 527 | 0.66 |
| 2MeIm | TEG-Me | 0.46 | >40 | 0.98 | 1309 | 12.24 | 996 | 0.52 |
| None | TEG-Me | 0.52 | >40 | 0.85 | 813 | 7.59 | 852 | 0.53 |
| 2MeIm | PEG | 0.48 | >35 | 0.96 | 994 | 10.61 | 657 | 0.84 |
| None | PEG | 0.51 | 17 | 0.80 | 682 | 8.27 | 601 | 0.63 |
| 2MeIm | TFE | 0.41 | 25 | 0.98 | 586 | 6.17 | 336 | 0.97 |
| None | TFE | 0.51 | 2 | NA | 313 | 4.65 | 561 | 0.31 |

Finally, Table 4 provides the properties of a membranes made by the methods set forth herein from PPO-BR various heterocyclic nucleophiles and additives. The ion conductivity ranges from 0.3 to 0.41 S/cm and the ion exchange capacity from 0.16 to 1.8 mmol/g.

TABLE 4
Addition of Chemical Diversity Elements

| Building | | Conductivity | Durability | | Water | OH Uptake | | IEC |
|---|---|---|---|---|---|---|---|---|
| Block | Additive | [S/cm] | [Days] | σ_{f}/σᵢ | uptake [%] | [%] | λ_{H2O} | [mmol/g] |
| 1,2,4-Tz | TEG | 0.41 | >60 | 0.93 | 571 | 5.14 | 1983 | 0.16 |
| Pyrazole | TEG | 0.39 | 13 | 0.71 | 568 | 5.32 | 863 | 0.37 |
| BzIm | TEG | 0.10 | >60 | 0.69 | 210 | 1.74 | 136 | 0.86 |
| 2MeIm | TEG + | 0.32 | >60 | 0.66 | | | | 0.85 |
| | 1,2,4-Tz | | | | | | | |
| 2MeIm | TEG + | 0.30 | >60 | 0.60 | | | | 0.88 |
| | Pyrazole | | | | | | | |
| 2MeIm | TEG + | 0.30 | >60 | 0.43 | | | | 0.80 |
| | BzIm | | | | | | | |
| 1,2,4-Tz | TEG + | 0.39 | >60 | 0.75 | 640 | 5.49 | 198 | 1.80 |
| | Pyrazole | | | | | | | |
| 1,2,4-Tz | TEG + | 0.32 | >60 | 0.67 | 662 | 5.60 | 404 | 0.91 |
| | BzIm | | | | | | | |
| 1,2,4-Tz | TEG + | 0.41 | >60 | 0.84 | | | | 1.18 |
| | 1,2,4-Tz | | | | | | | |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments, variations, and refinements may be combined to form further embodiments of the invention.

What is claimed is:

1. An electrochemical device comprising:
an anode;
a cathode; and
a separator interposed between the anode and cathode comprising an anion conductive membrane including a porous substrate having hydrophilic moieties bonded thereto to increase water availability in a vicinity of ionogenic sites contributing to conductivity of the membrane in a presence of aqueous phases imbibed therein.

2. The electrochemical device of claim 1, wherein the hydrophilic moieties are functionalized with cations.

3. The electrochemical device of claim 2, wherein the cations are chemically modified to hinder degradation by substitution or elimination reactions.

4. The electrochemical device of claim 1, wherein the hydrophilic moieties are non-ionic.

5. The electrochemical device of claim 1, wherein the substrate is polymeric.

6. The electrochemical device of claim 5 wherein the substrate includes a polymer having polymer fragments represented by the following formula: 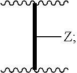
and Z is the residue of a nucleophile.

7. The electrochemical device of claim 6 wherein Z is selected from the group consisting of: 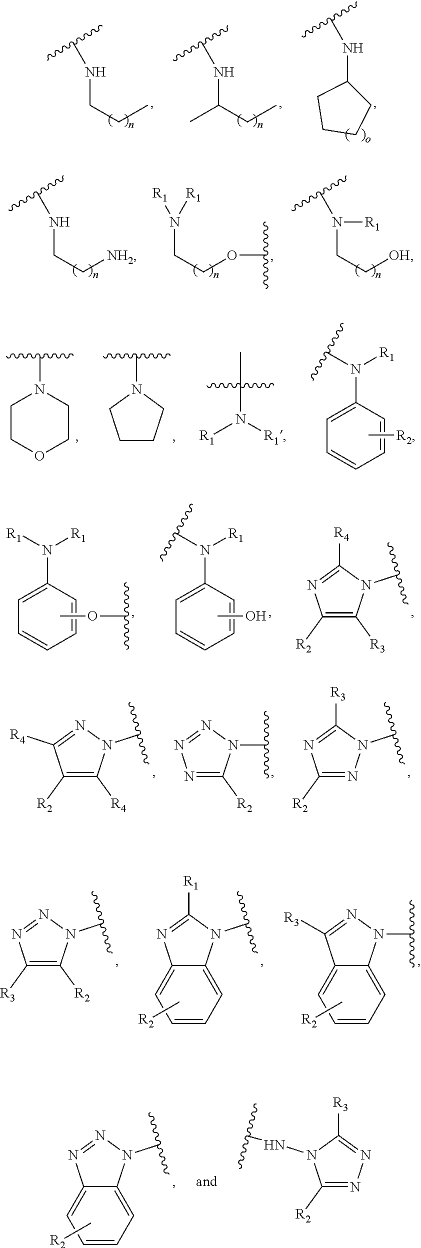
where
o is 1, 2, or 3; n is 1-5; R₁, R_{1′} are each independently H, C₁₋₆ alkyl, or benzyl; and R₂, R₃, R₄ are each independently C₁₋₆ alkyl, C₆₋₁₀ aryl, C₆₋₁₀ heteroaryl, CN, halo, NH₂, SH, SMe, NO₂, or CO₂H.

8. The electrochemical device of claim 5, wherein polymer chains of the substrate are cross-linked.

9. The electrochemical device of claim 8, wherein polymer chains of the substrate are cross-linked with a linking moiety Y selected from the group consisting of: 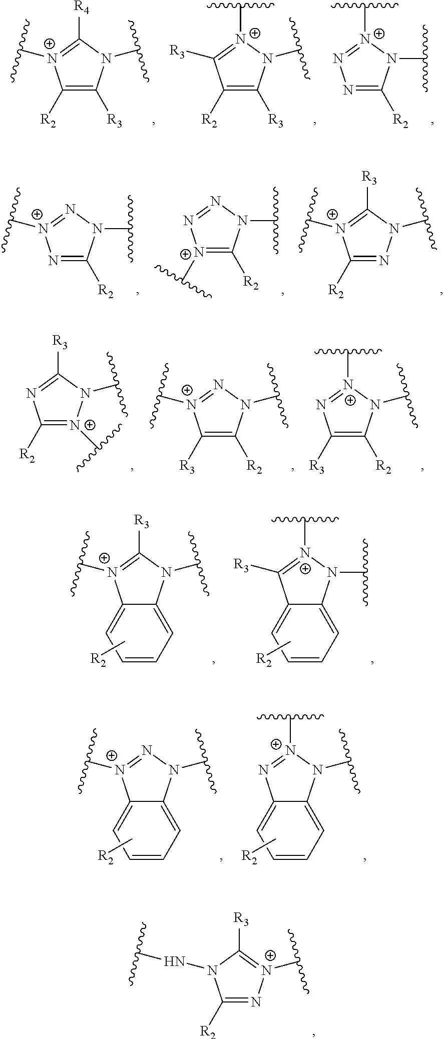
and combinations thereof,
R₂, R₃, R₄ are each independently C₁₋₆ alkyl, C₆₋₁₀ aryl, C₆₋₁₀ heteroaryl, CN, halo, NH₂, SH, SMe, NO₂, Or CO₂H.

10. The electrochemical device of claim 9 wherein the substrate includes a polymer having polymer fragments represented by the following formula: 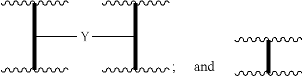
and is a section of a polymeric backbone.

11. The electrochemical device of claim 6, wherein polymer chains of the substrate are cross-linked by a moiety having the formula: 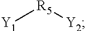
R₅ is a linking group; and
Y₁ and Y₂ are each independently selected from the group consisting of: 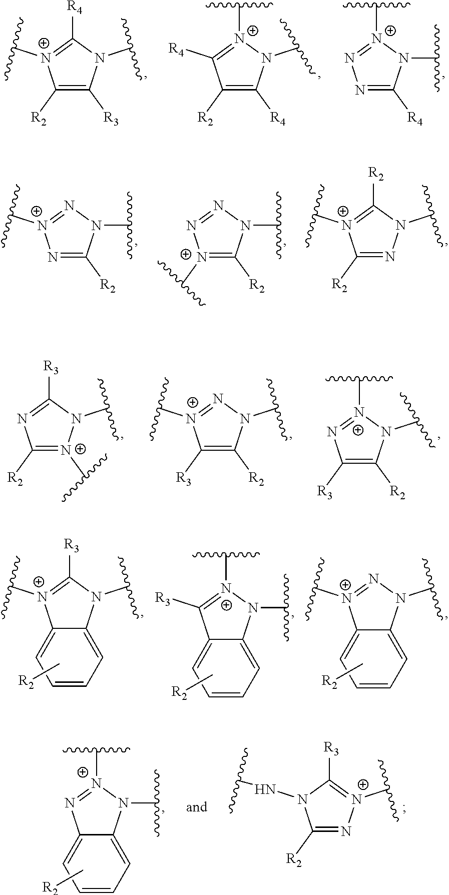
where R₂, R₃, R₄ are each independently C₁₋₆ alkyl, C₆₋₁₀ aryl, C₆₋₁₀ heteroaryl, CN, halo, NH₂, SH, SMe, NO₂, or CO₂H.

12. The electrochemical device of claim 11 wherein the substrate includes a polymer having polymer fragments represented by the following formula:

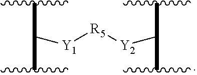

13. The electrochemical device of claim 11 wherein the substrate includes a polymer having polymer fragments represented by the following formula: 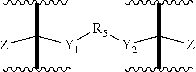
wherein Z is the residue of a nucleophile.

14. The electrochemical device of claim 13 wherein Z is selected from the group consisting of: 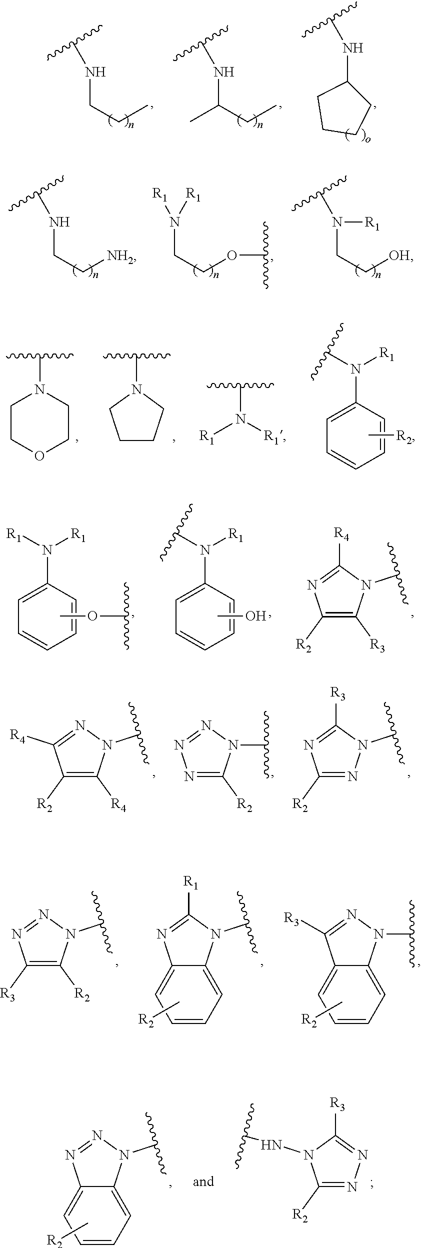
o is 1, 2, or 3;
n is 1 to 5; and
R₁, R_{1′} are each independently H, C₁₋₆ alkyl, or benzyl; and
R₂, R₃, R₄ are each independently C₁₋₆ alkyl, C₆₋₁₀ aryl, C₆₋₁₀ heteroaryl, CN, halo, NH₂, SH, SMe, NO₂, or CO₂H

15. The electrochemical device of claim 1, wherein the substrate is inorganic.

16. The electrochemical device of claim 1 wherein the water uptake is from 40 to 1500 percent.

17. The electrochemical device of claim 1 wherein the ion conductivity is from 0.3 to 6 S/cm and the ion exchange capacity is from 0.3 to 1.5 mmol/g.

18. An electrochemical device comprising:
an anode;
a cathode; and
a separator interposed between the anode and cathode comprising an anion conductive membrane including a porous cross-linked polymeric substrate having non-ionic hydrophilic moieties bonded thereto to increase water availability in a vicinity of ionogenic sites contributing to conductivity of the membrane in a presence of aqueous phases imbibed therein, the hydrophilic moieties being functionalized with cations that are chemically modified to hinder degradation by substitution or elimination reactions.

19. The electrochemical device of claim 18, wherein polymer chains of the polymeric substrate are cross-linked with a linking moiety Y selected from the group consisting of: 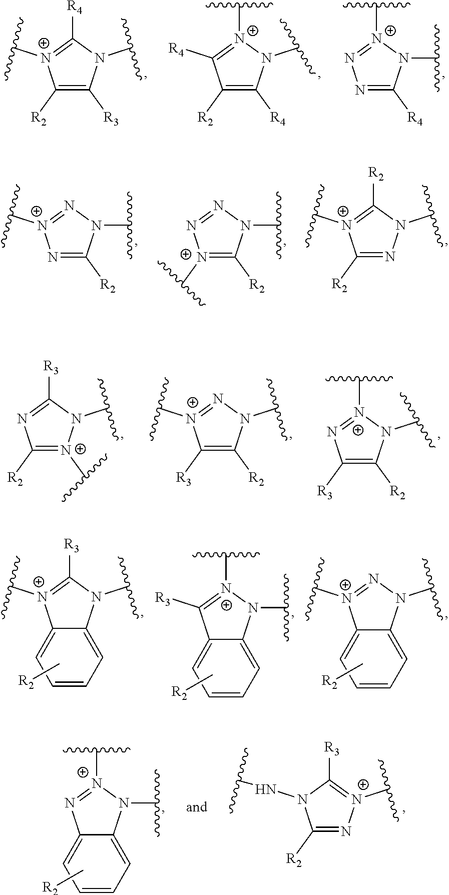
and combinations thereof,
R₂, R₃, R₄ are each independently C₁₋₆ alkyl, C₆₋₁₀ aryl, C₆₋₁₀ heteroaryl, CN, halo, NH₂, SH, SMe, NO₂, or CO₂H.

20. The electrochemical device of claim 19 wherein the substrate includes a polymer having polymer fragments represented by the following formula: 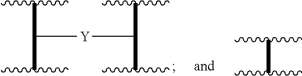
is a section of a polymeric backbone.

21. The electrochemical device of claim 18, wherein polymer chains of the substrate are cross-linked by a moiety having the formula: 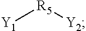
R₅ is a linking group; and
Y₁ and Y₂ are each independently selected from the group consisting of: 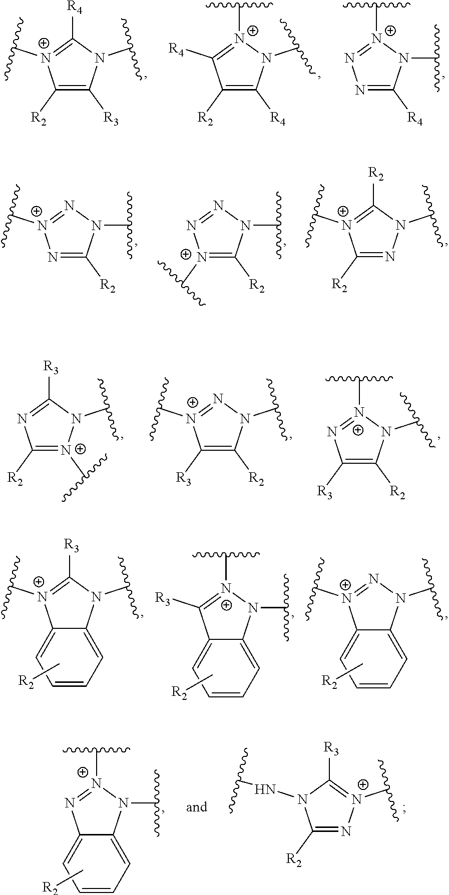
where R₂, R₃, R₄ are each independently C₁₋₆ alkyl, C₆₋₁₀ aryl, C₆₋₁₀ heteroaryl, CN, halo, NH₂, SH, SMe, NO₂, or CO₂H.

22. The electrochemical device of claim 21 wherein the substrate includes a polymer having polymer fragments represented by the following formula:

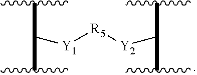

23. The electrochemical device of claim 18 wherein the substrate includes a polymer having polymer fragments represented by the following formula: 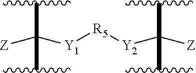
wherein Z is the residue of a nucleophile.

24. The electrochemical device of claim 23 wherein Z is selected from the group consisting of: 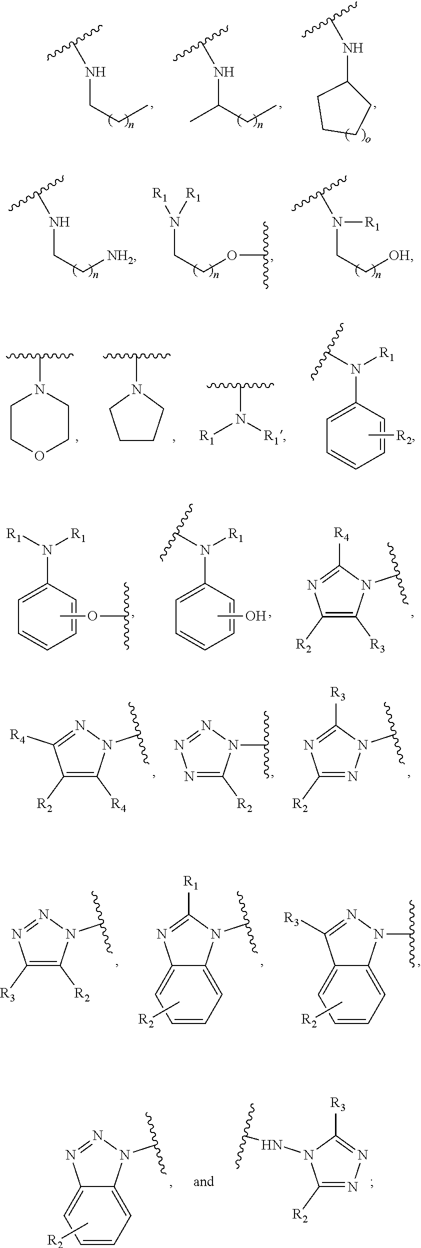
o is 1, 2, or 3;
n is 1 to 5;
R₁, R_{1′} are each independently H, C₁₋₆ alkyl, or benzyl; and
R₂, R₃, R₄ are each independently C₁₋₆ alkyl, C₆₋₁₀ aryl, C₆₋₁₀ heteroaryl, CN, halo, NH₂, SH, SMe, NO₂, or CO₂H
